(19) United States
(12) Patent Application Publication
(10) Pub. No.: US 2025/0202003 A1
(43) Pub. Date: Jun. 19, 2025

(54) CONTAINERIZED BATTERY SYSTEM

(71) Applicant: fleetzero Inc., Brighton, AL (US)

(72) Inventors: Steven Thomas Henderson, New Orleans, LA (US); Michael Patrick James Carter, Houston, TX (US); Thomas Clifford Smillie, III, Birmingham, AL (US); Brock jEFFREY Hashimoto, Gambrills, MD (US)

(21) Appl. No.: 18/847,657

(22) PCT Filed: Mar. 14, 2023
(86) PCT No.: PCT/US2023/015205

§ 371 Date: Sep. 16, 2024

Related U.S. Application Data
(60) Provisional application No. 63/319,758, filed on Mar. 14, 2022.

(51) Int. Cl. H01M 50/24; A62C 3/16; B63B 25/00; B63J 2/12; H01M 4/58; H01M 10/42; H01M 10/613; H01M 10/625; H01M 10/6561; H01M 50/209; H01M 50/249; H01M 50/289; H01M 50/296; H01M 50/509; H01M 50/583

(52) U.S. Cl. CPC H01M 50/24; A62C 3/16; H01M 4/5825; H01M 10/425; H01M 10/613; H01M 10/625; H01M 10/6561; H01M 50/209; H01M 50/249; H01M 50/289; H01M 50/296; H01M 50/509; H01M 50/583; B63B 25/004; B63J 2/12; H01M 2010/4271; H01M 2010/4278; H01M 2200/103; H01M 2220/20

(57) ABSTRACT

A containerized battery system can include a container, a framework, battery cells, and an electrical coupling. The container can be installed within and removed from a container space on a vessel. The framework can be situated within the container and can define multiple framework compartments therein. The battery cells can be arranged into battery modules that provide power to the vessel. Each battery module can be removably disposed as a combined unit within a framework compartment. Each battery cell within a battery module can be coupled together in parallel and the multiple battery modules can be coupled together in series. The electrical coupling can be configured to facilitate the recharging of the battery cells while the battery cells are within the container. The containerized battery system can also include a fire prevention system, an environmental control system, and a power management system.

### TECHNICAL FIELD

The present disclosure relates generally to freight shipping, and more particularly to power usage on freight shipping vessels.

### BACKGROUND

The worldwide shipping industry involves billions of dollars and millions of people. Large amounts of freight are shipped constantly on huge ships throughout the oceans of the world. Such freight is typically shipped in large containers that can be loaded and unloaded from ships, trains, and other shipping vehicles. A single freight ship can have dozens or even hundreds of these containers full of freight stacked thereupon for shipping the freight long distances between ports across the oceans of the world. As will be readily appreciated, the amounts of power required to move these freight ships can be enormous, and the predominant use of power today for moving freight ships involves the burning of fossil fuels.

Unfortunately, the burning of fossil fuels to power freight ships results in massive amounts of undesirable emissions to the environment. Furthermore, the overall costs of using fossil fuels continues to rise while the world supply is limited and may eventually run out. Due to these and other factors, there are increasing external pressures on the shipping industry to move towards lower emission power sources that involve less reliance on fossil fuels.

Although traditional ways of powering ships and other freight carrying vehicles have worked well in the past, improvements are always helpful. In particular, what is desired are power generating systems for ships and other freight carrying vehicles that result in lower environmental emissions and that are less reliant on fossil fuels.

### SUMMARY

It is an advantage of the present disclosure to provide power generating systems for ships and other freight carrying vehicles that result in lower environmental emissions and that are less reliant on fossil fuels. The disclosed features, apparatuses, systems, and methods provide alternative power sources for large container ships and other freight carrying vehicles. These advantages can be accomplished at least in part by providing a containerized battery system having a collection of batteries within a shipping container that is configured to be installed onto and removed from a container ship.

In various embodiments of the present disclosure, a containerized battery system can include a container, a framework, a plurality of battery cells, and an electrical coupling. The container can have an outer housing and can be configured to be installed within and removed from a container space on a vessel. The framework can be situated within the container and can define multiple framework compartments therein. The plurality of battery cells can be arranged into multiple battery modules configured to provide power to the vessel. Each battery module can be removably disposed as a combined unit within a framework compartment. Each battery cell within a battery module can be coupled together in parallel and the multiple battery modules can be coupled together in series. The electrical coupling can be located along the outer housing of the container and can be configured to facilitate the recharging of the plurality of battery cells while the battery cells are located within the container.

In various detailed embodiments, the framework can include horizontally disposed stabilizing components situated across vertically disposed support stantions. Also, the framework compartments can be situated within the framework in an arrangement that is at least two framework compartments tall by at least four framework compartments wide by at least four framework compartments long. In specific arrangements, the framework compartments can be situated within the framework in an arrangement that is four framework compartments tall by ten framework compartments wide by six framework compartments long. Each battery module can include spacing components configured to provide airflow spacing between separate battery modules. Each battery module can include at least four battery cells, and in some arrangements each battery module can include nine battery cells.

In further detailed embodiments, one or more of the multiple battery modules can include a switch configured to uncouple its respective battery module from the overall series of battery modules such that the remaining overall series of battery modules remain fully functional. Each battery cell can be a lithium iron phosphate based battery having a voltage of about 1 to 4 volts, and the combined capacity of all battery cells can be about two megawatt hours. Each battery cell can have a fuse coupled thereto to allow its respective battery module to remain functional in the event of a failure of any battery cell within the battery module.

In still further detailed embodiments, the containerized battery system can include a fire prevention system and/or a fire suppression system located within the container. The fire prevention system can be configured to scavenge oxygen inside the container, to maintain an internal pressure within the containerized battery system that is greater than the ambient pressure outside the containerized battery system, or both. The containerized battery system can also include an environmental control system located within the container. The environmental control system can provide cooling within the containerized battery system without any air exchange between the air inside the container and ambient air outside the container, and can be configured to maintain the temperature within the containerized battery system at between about 25 to 30 degrees C. The environmental control system can also prevent ambient air outside the container from entering the container.

The containerized battery system can also include a power management system component located about the container, wherein the power management system component can be configured to collect data regarding the status of the battery cells located within the containerized battery system and communicate the data to one or more entities located outside the containerized battery system along power lines coupled to the battery cells that also transmit power from the battery cells. The power management system component can include at least one separate sensor and at least one separate processor located at every battery cell.

In various arrangements, the container can be about 4 feet tall by about 20 feet long by about 8 feet wide. In other arrangements, the container can be about 8 feet tall by about 20 feet long by about 8 feet wide.

In further embodiments of the present disclosure, various methods of operating a vessel using a containerized battery system are provided. Pertinent process steps can include providing a plurality of battery cells within a container, charging the battery cells, installing the container on a vessel, coupling the container to a power system, drawing power from the battery cells, facilitating movement of the vessel, removing the container from the vessel, recharging the battery cells, and reinstalling the container to the vessel. The provided battery cells can be arranged into multiple battery modules within a container such that each battery cell within a battery module is coupled together in parallel and the multiple battery modules are coupled together in series. The battery cells can be charged through an electrical coupling coupled to the container. The container can be installed within a container space on the vessel. The electrical coupling can be used to couple the container to the power system located on the vessel. Power from the battery cells can be drawn through the electrical coupling. Movement of the vessel can be facilitated using the power drawn from the battery cells. The battery cells can be recharged while the battery cells are located within the container. The container can be reinstalled within the container space on the vessel.

Various detailed embodiments can include the additional process steps of monitoring automatically the statuses of the plurality of battery cells, communicating automatically the battery cell statuses to a processing unit, and adjusting automatically the operation of an environmental control system within the container based on the communicated battery cell statuses. The vessel can be a cargo ship, although other vessels or vehicles are also possible.

In still further embodiments of the present disclosure, various methods of managing a network of containerized battery systems are provided. Pertinent process steps can include monitoring the statuses of a plurality of containerized battery systems within the network, wherein each containerized battery system includes a plurality of battery cells arranged into multiple battery modules within a container, and wherein each battery cells within a battery module are coupled together in parallel and the multiple battery modules are coupled together in series, installing a first containerized battery system into a first vessel based on the monitored status of the first containerized battery system, facilitating movement of the first vessel using power drawn from the first containerized battery system, removing the first containerized battery system from the first vessel, installing a second containerized battery system into the first vessel based on the monitored status of the second containerized battery system, recharging the first containerized battery system, updating the status of the first containerized battery system, installing the first containerized battery system into a second vessel, and facilitating movement of the second vessel using power drawn from the first containerized battery system.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods of use regarding containerized battery systems. These drawings in no way limit any changes in form and detail that may be made to the disclosure by one skilled in the art without departing from the spirit and scope of the disclosure.

FIG. 1 illustrates in side cross-section view an example containerized battery system according to one embodiment of the present disclosure.

FIG. 2 illustrates in top plan view the containerized battery system of FIG. 1 according to one embodiment of the present disclosure.

FIG. 3A illustrates in top plan view an example container for a containerized battery system having all batteries removed according to one embodiment of the present disclosure.

FIG. 3B illustrates in side elevation view the container of FIG. 3A according to one embodiment of the present disclosure.

FIG. 4A illustrates in top plan view an example battery module having multiple battery cells for use in a containerized battery system according to one embodiment of the present disclosure.

FIG. 4B illustrates in side elevation view the battery module of FIG. 4A according to one embodiment of the present disclosure.

FIG. 4C illustrates in end elevation view the battery module of FIG. 4A according to one embodiment of the present disclosure.

FIG. 5A illustrates in side elevation view an example battery module stack for use in a containerized battery system according to one embodiment of the present disclosure.

FIG. 5B illustrates in end elevation view the battery module stack of FIG. 5A according to one embodiment of the present disclosure.

FIG. 6A illustrates in bottom plan view an example venting arrangement for a containerized battery system according to one embodiment of the present disclosure.

FIG. 6B illustrates in side elevation view an example support stantion for a containerized battery system according to one embodiment of the present disclosure.

FIG. 7 illustrates a schematic diagram of an example electrical arrangement for a containerized battery system according to one embodiment of the present disclosure.

FIG. 8 illustrates a flowchart of an example method of operating a vessel using a containerized battery system according to one embodiment of the present disclosure.

FIG. 9 illustrates a flowchart of an example method of managing a network of containerized battery systems according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for powering vessels using alternative power sources. The disclosed embodiments provide power generating systems for vessels that result in lower environmental emissions and that are less reliant on fossil fuels. These advantages can be accomplished at least in part by providing a containerized battery system having a collection of battery cells within a shipping container that is configured to be installed onto and removed from a vessel.

In particular, the disclosed embodiments can involve the use of battery packs that can be installed within industry approved containers adhering to existing weight limitations of the container. The disclosed battery packs can be loaded into a dedicated battery hold or other designated location of a vessel using existing port infrastructure, electrically connected to the vessel, discharged as required for vessel operations, electrically disconnected at the end of the operational cycle, recharged on the vessel or unloaded from the vessel for recharging, and removed from rotation as required for scheduled maintenance or emergency repairs. In various arrangements, the battery packs can be capable of collectively providing 2 megawatts of direct current at an output of 480 VAC, 3 phase power to act in a hybrid or direct replacement capacity for main and auxiliary power generation onboard various types of vessels.

In various arrangements, the container can be a half-size industry standard shipping container, which can be about 4 feet tall by about 20 feet long by about 8 feet wide. In other arrangements, the container can be a full-size industry standard shipping container, which can be about 8 feet tall by about 20 feet long by about 8 feet wide. The container can be removed and reinstalled to the vessel in these or any other arrangements.

Although various embodiments disclosed herein discuss the provided containerized battery systems for freight or cargo ships, it will be readily appreciated that the disclosed features, apparatuses, systems, and methods can similarly be used for other purposes as may be desired. In various detailed examples, which are merely illustrative and non-limiting in nature, the disclosed containerized battery systems can be used for other vehicles, such as trains, planes, or trucks, for example. The use of cargo or freight on the vessel or vehicle is also not necessary in all embodiments. For example, the disclosed system can be used to power cruise ships or other types of vessels or vehicles. Other applications, arrangements, and extrapolations beyond the illustrated embodiments are also contemplated.

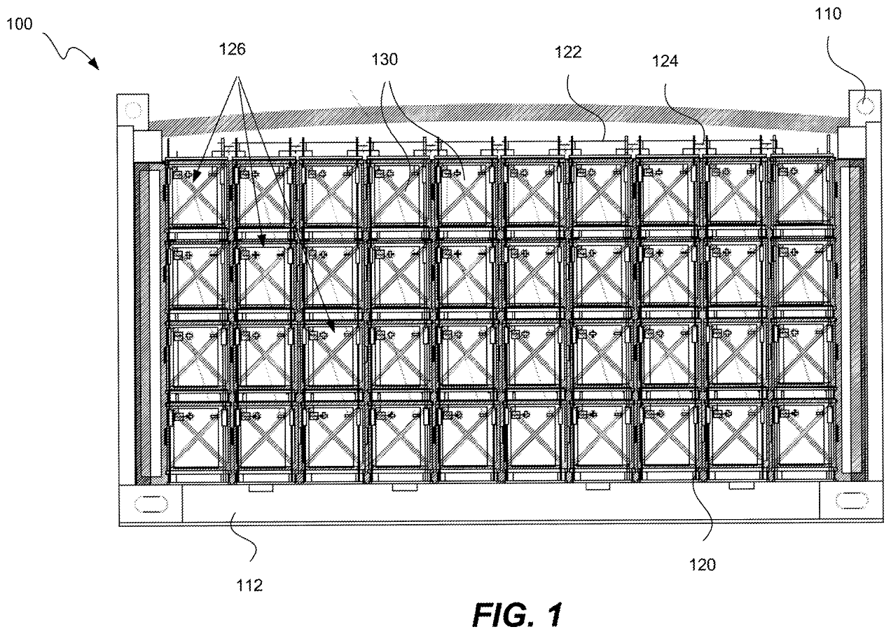

Referring first to FIG. 1, an example containerized battery system according to one embodiment of the present disclosure is illustrated in side cross-section view. Containerized battery system 100 can include a container 110 having an outer housing 112 that may have walls, a floor, and a removable top. A framework 120 can be disposed within container 110, which framework can include horizontally disposed stabilizing components 122 situated across vertically disposed support stantions 124, which together are arranged to provide structural stability to the framework. Various components of container 110 and framework 120 can be formed of a rigid material, such as steel, for example.

Framework 120 can be arranged to define multiple framework compartments 126 therein. In various arrangements, each framework compartment 126 can be configured to hold a battery module 130 therein. Framework compartments 126 can be arranged such that battery modules 130 can be readily installed into and removed from the compartments. As shown, framework 120 can be formed such that framework compartments 126 are disposed atop each other, such in stacks of four compartments. Of course, framework 120 can alternatively be formed having more of fewer framework compartments 126 in a given stack.

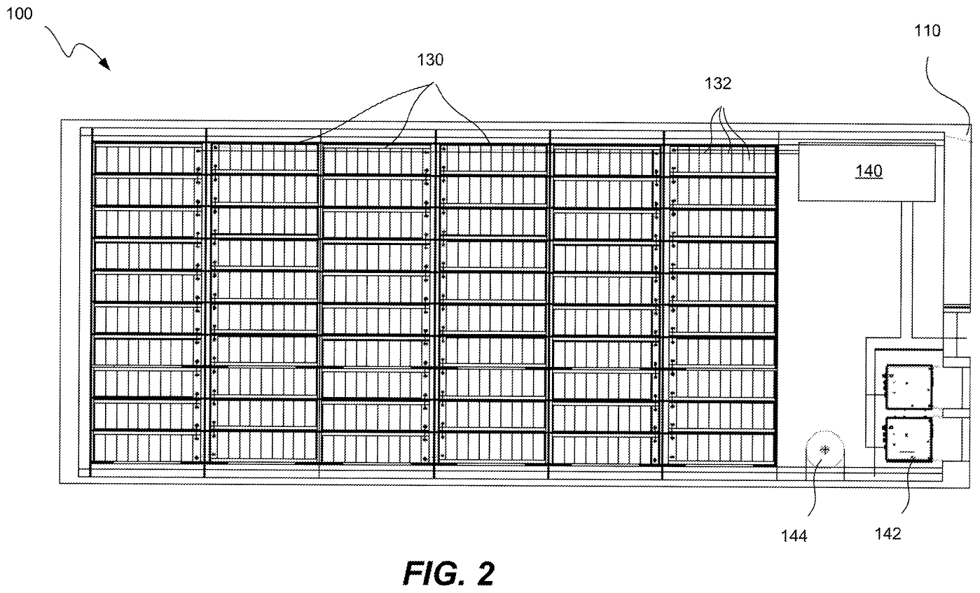

Continuing with FIG. 2 containerized battery system 100 of FIG. 1 is shown in top plan view. Again, a plurality of battery modules 130 can be contained in framework compartments within container 110. Battery modules 130 can be arranged within framework compartments in stacks (such as stacks of four modules) that are situated within the framework in an arrangement that is about ten framework compartments wide by about six framework compartments long. Of course, alternative arrangements can be used having more of fewer framework compartments in length and width. In the overall arrangement shown in FIGS. 1 and 2, there can be a total of 240 framework compartments arranged in a box shape.

Each battery module 130 can have multiple battery cells 132 arranged side by side. For example, a given battery module 130 can have nine battery cells arranged in parallel. In the overall arrangement shown in FIGS. 1 and 2, this would result in a total of 2160 battery cells in a fully loaded containerized battery system. Of course, more or fewer battery cells can be used in a given fully loaded system, and a system may be operated without battery modules and battery cells in all possible framework compartments.

In various embodiments, containerized battery system 100 can also include a VFD drive, charge setup and direct current bus 140 coupled to the collection of stacked battery modules. Containerized battery system 100 can also include an environmental control system 142 and a fire prevention system 144 located within container 100. Environmental control system 142 can include one or more air conditioning units.

Fire prevention system 144 can be located within container 110 and may include one or more fire prevention components and fire suppression components. In some arrangements, fire prevention system 144 can be configured to scavenge oxygen inside the container, such as by use of a desiccant or other suitable material, such that oxygen levels inside the container are kept sufficiently low to prevent or reduce the effects of an internal fire. Fire prevention system 144 can also include one or more components configured to liquify any materials that leak from any of the battery cells, again to prevent or reduce the effects of any fire. In various arrangements, fire prevention system 144 can also maintain an internal pressure within the containerized battery system that is greater than the ambient pressure outside the containerized battery system, such that oxygen within ambient air outside the container is not allowed to enter the container.

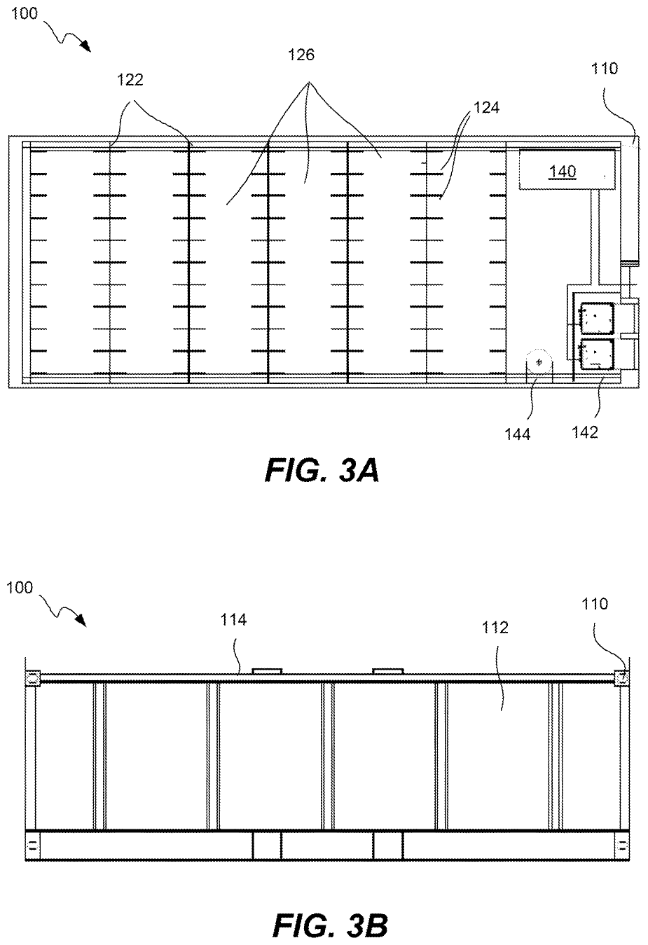

FIG. 3A illustrates in top plan view an example container 110 for a containerized battery system 100 having all batteries removed, while FIG. 3B depicts the container in side elevation view. As shown in FIG. 3A, all battery modules have been removed from container 110, such that the various empty framework compartments 126 are clearly visible. Again, these framework compartments 126 are disposed within a framework 120 that can include horizontally disposed stabilizing components 122 situated across vertically disposed support stantions 124. As shown in FIG. 3B, container 110 can include an outer housing 112, which may include one or more removable lid components or doors 114 located at the top of the container to facilitate the installation and removal of battery modules from within the container.

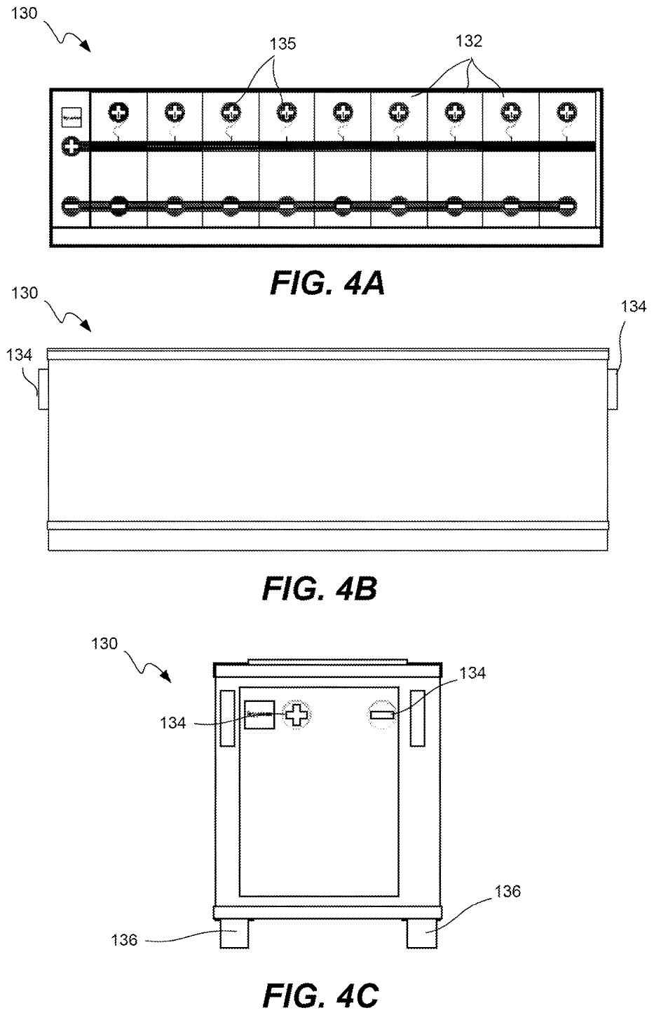

Turning next to FIGS. 4A through 4C, an example battery module having multiple battery cells for use in a containerized battery system is illustrated in top plan, side elevation, and end elevation views respectively. Battery module 130 can have a plurality of battery cells 132 situated side by side and arranged in parallel, such that power from all of the battery cells within a given battery module is delivered together at one or more module terminals 134. Such module terminals 134 can be located along the edge walls of each battery module 130, for example. In various arrangements, each battery cell 132 can have its own separate fuse 135, such that the failure of any cell can result in that cell being taken offline while the rest of the battery module continues to function with the remaining battery cells. Each battery module 130 can also have one or more spacing components 136 located at the bottom, top, and/or sides of the module, so as to provide spacing between modules and facilitate airflow for cooling of the overall containerized battery system. For example, spacing feet 136 can be located at the bottom of each module such that gaps between modules are created when the modules are stacked.

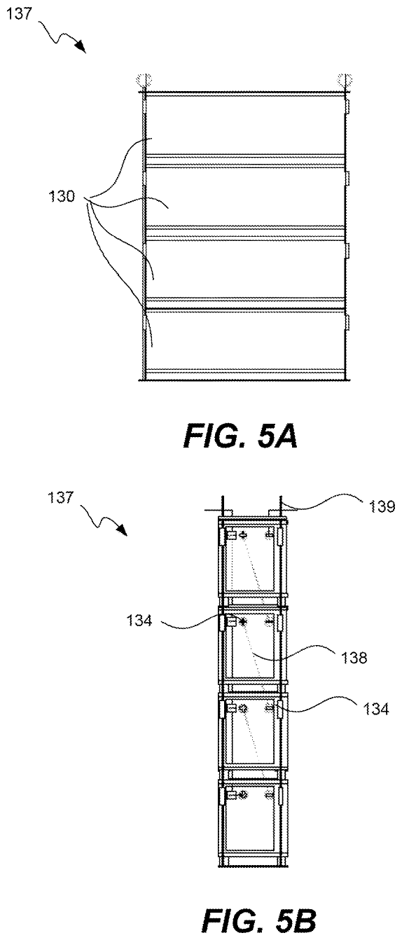

FIG. 5A depicts in side elevation view an example battery module stack for use in a containerized battery system, while FIG. 5B illustrates the battery module stack in end elevation view. Battery module stack 137 can be a vertical stack of multiple battery modules 130, such as four modules per stack, for example. Terminals 134 of each battery module 130 can be electrically connected using bus bars 138, which can be copper wires arranged diagonally across the ends of the modules within the stack, for example. Each battery module stack 137 can also have stack electrical connectors 139 configured to electrically couple the stack to other stacks and/or an overall power connection within the container. Multiple battery modules can be arranged into a battery module stack 137 as shown, such that the entire stack can be installed and removed as a single unit within the containerized battery system.

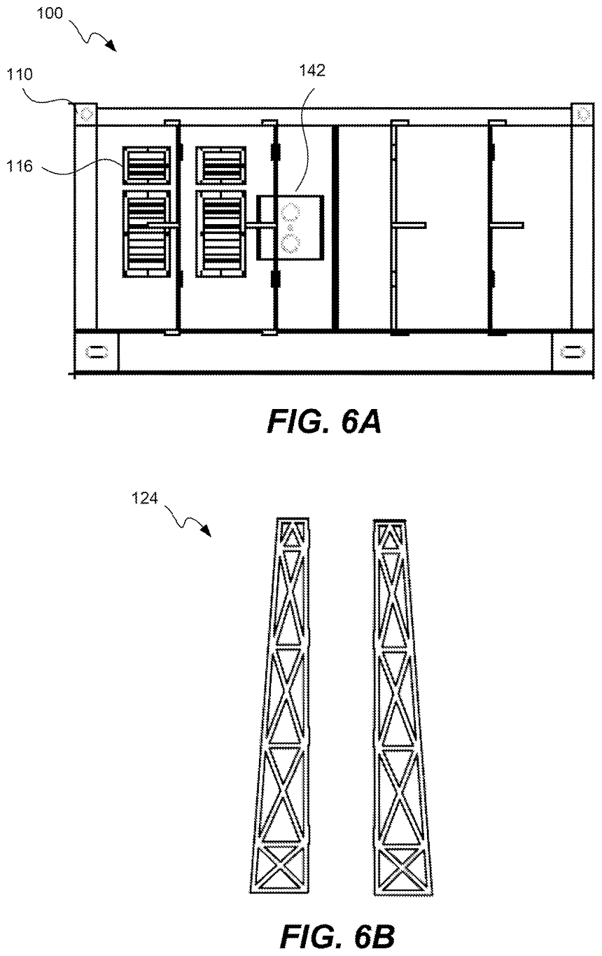

Turning next to FIG. 6A an example venting arrangement for a containerized battery system is shown in bottom plan view. Containerized battery system 100 can include one or more air vents or passages 116 in the floor of container 110 that allow for the passage of air or gases from inside the container to ambient outside the container. Vents or passages 116 can be coupled to and controlled by an environmental control system 142 located inside container 110, for example. In various arrangements, environmental control system 142 can be arranged such that ambient air does not pass into container 110 from outside the container. In such arrangements, check valves or other suitable components coupled to vents or passages 116 can ensure that outside air does not enter inside container 110.

In various arrangements, environmental control system 142 can provide cooling within the containerized battery system without any air exchange between the air inside the container and ambient air outside the container. This can be accomplished using an internal air cooling and circulation system that keeps all air within the container itself. Environmental control system 142 can be configured to maintain the temperature within the containerized battery system at between about 20 to 40 degrees C., and in some arrangements between about 25 to 30 degrees C.

FIG. 6B illustrates in side elevation view an example support stantion for a containerized battery system. Support stantion 124 can define any suitable arrangement of various beams, poles, and/or other components arranged to provide support to other components of the framework within the container. For example, support stantion 124 can be formed of beams arranged in a cross-support structure within an overall frame that narrows from the base of the support stantion toward its top, as shown. Other support arrangements are also possible.

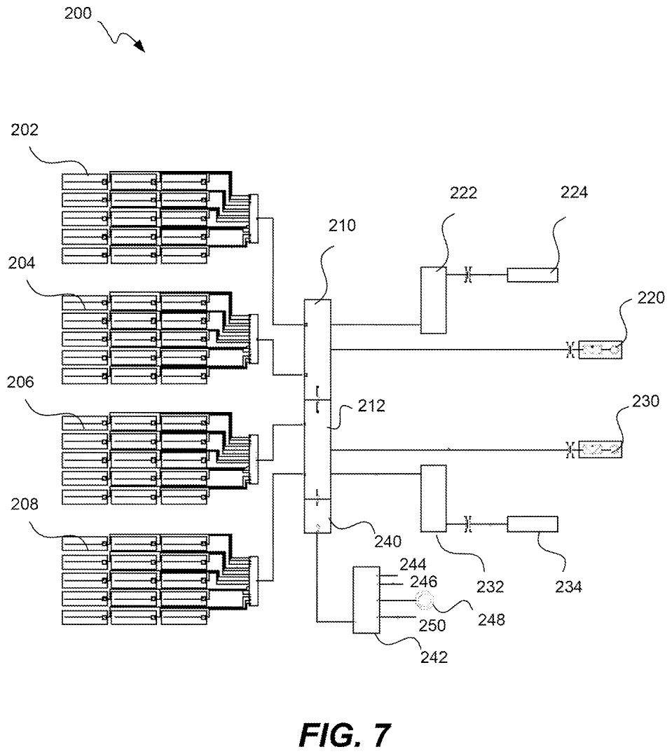

FIG. 7 illustrates a schematic diagram of an example electrical arrangement for a containerized battery system. Electrical arrangement 200 can include a plurality of battery banks 202, 204, 206, 208, which can be electrically coupled to one or more busses, such as a port bus 210 and an STDB bus 212. The port bus 210 can in turn be coupled to a port propulsion system 220 and port MCCs 222, which are in turn coupled to port LCCs 224. The STDB bus 212 can in turn be coupled to an STDB propulsion system 230 and STDB MCCs 232, which are in turn coupled to STDB LCCs 234. An EDG tie 240 at STDB bus 212 can be coupled to an electrical generator bus 242, which in turn can be coupled to various electrical components, such as electrical lighting panels 244, an electrical service line 246, an electrical generator 248, and an electrical battery management system 250, among other possible electrical components.

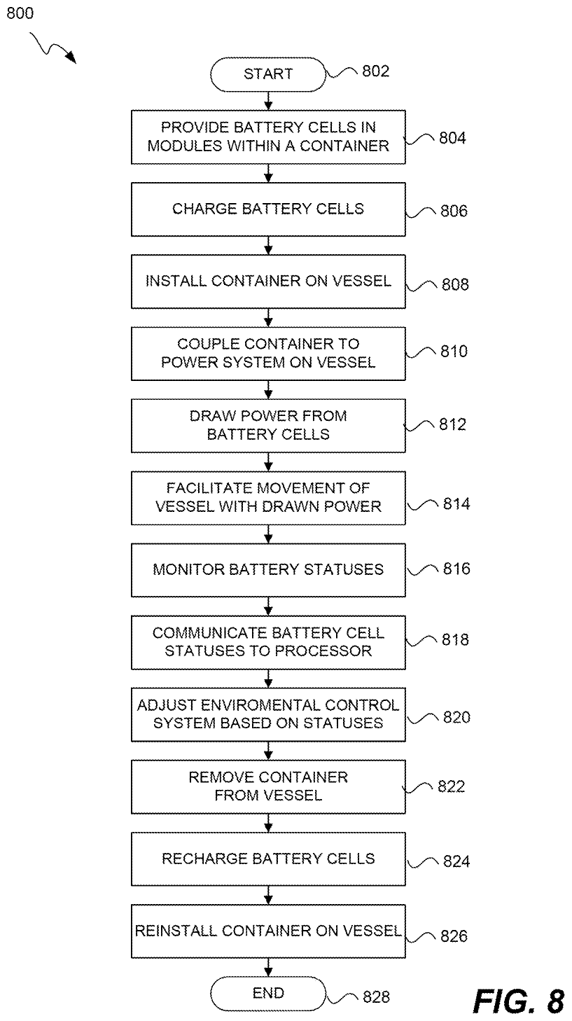

Next, FIG. 8 illustrates a flowchart of an example method of operating a vessel using a containerized battery system. In various embodiments, method 800 can be applied using the various systems, devices, and features provided above. After a start step 802, a first process step 804 can involve providing battery cells arranged in battery modules within a container. The battery cells can be arranged in parallel within the battery modules, and the battery modules can be arranged in series with respect to each other. Battery modules can be stacked and arranged into compartments within a framework within the container, as detailed above.

At a following process step 806, the battery cells can be charged. This can involve charging the battery cells through an electrical coupling coupled to the container and providing electrical power from an outside source.

At subsequent process step 808, the container can be installed onto a vessel. This can involve installing the container within a container space on the vessel. Such a container space can be one designated for containerized battery systems for example and can be located at any suitable place on the vessel. In some arrangements, the container can be installed in stacks and/or along with many other similar containerized battery systems. Dozens or even hundreds of same or similar containerized battery systems can be installed, used, and removed together on a given vessel.

At a following process step 810, the container can be coupled to a power system on the vessel. This can involve using the electrical coupling on the container itself. At process step 812, power can be drawn from the battery cells, which power again can be drawn through the electrical coupling on the container.

At the next process step 814, movement of the vessel can be facilitated with the drawn power. That is, the vessel can be propelled or otherwise moved using the power drawn from the plurality of battery cells through the electrical coupling. Of course, the power drawn from the containerized battery system can be combined with power that is similarly drawn from other containerized battery systems on the vessel for moving the vessel.

At process step 816, the statuses of the battery cells can be monitored. This can be done automatically, such as by the use of individual sensors and processors located at each battery cell. At the next process step 818, the statuses of the battery cells can be communicated to a processor of a battery management system. This can also be done automatically, such as by communicating cell statuses and other data over the power lines themselves. For example, a pulsed signal can be sent over the power lines to communicate data.

At process step 820, an environmental control system on the vessel can be adjusted based on the communicated statuses. This can also be done automatically. Data regarding the battery cell statuses can be communicated automatically to a battery management system processor, which then uses that data to perform a number of functions, one of which can be to adjust or otherwise control an environmental control system within the container. For example, when the temperature of one or more battery cells rises above a threshold level, then this status can be communication to the battery management system processor, which in turn can activate cooling unit(s) of the environmental control system to cool the air inside the container.

At a subsequent process step 822, the containerized battery system can be removed from the vessel. Again, the containerized battery system can be removed with one or more other containerized battery systems on the vessel, such as where multiple systems have used much, or all, of the power stored in their battery cells. At the next process step 824, the battery cells can be recharged. This can take place outside the vessel, such as at a designated charging location or station on a shipping port, for example. Recharging the battery cells can involve coupling a power source to the electrical coupling on the container and providing power through the electrical coupling to the battery cells within the container.

At process step 826, the containerized battery system can then be reinstalled onto the vessel. Reinstallation can be to the same or another designated container space on the vessel. The containerized battery system can have some or all of its battery cells recharged prior to reinstallation. In some arrangements, the containerized battery system can be reinstalled to the same vessel from where it was removed. In other arrangements, the containerized battery system can be installed to a different vessel for use in a similar manner. The method then ends at end step 828.

It will be appreciated that the foregoing method 800 may include additional steps not shown, and that not all steps are necessary in some embodiments. For example, additional steps may include removing individual battery cells from the container, such as to perform maintenance on or replace the removed cells. Other process steps can involve taking one or more cells offline due to cell failure and continuing operation with the remaining cells within a cell module. Furthermore, the order of steps may be altered as desired, and one or more steps may be performed simultaneously. For example, step 824 be performed prior to or along with step 822. As another example, process steps 812-820 can be performed simultaneously. Other process steps, details, and arrangements are also possible.

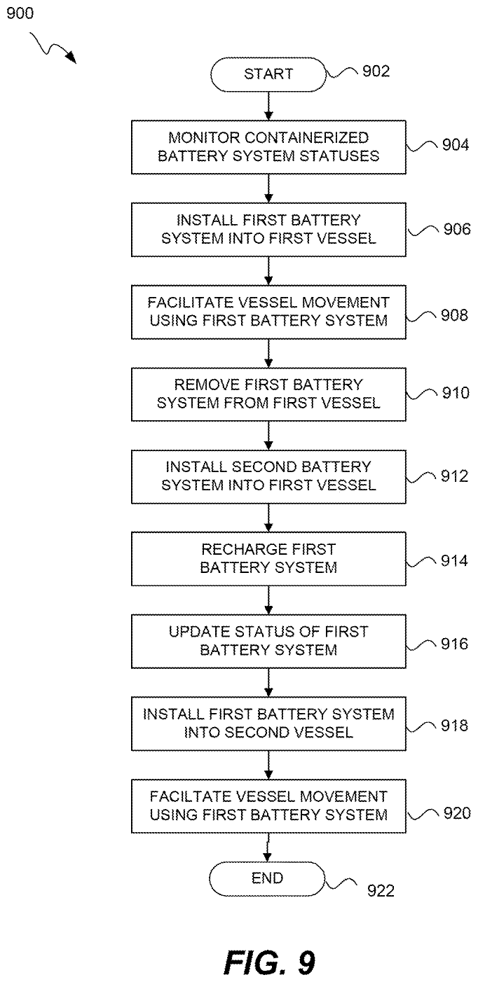

Lastly, FIG. 9 illustrates a flowchart of an example method of managing a network of containerized battery systems. In various embodiments, method 900 can be applied using the various systems, devices, and features provided above. After a start step 902, a first process step 904 can involve monitoring the statuses of battery cells within a containerized battery system. This can be done automatically, such as by sensors and processors located at each battery cell within the overall containerized battery system.

At a following process step 906, a first containerized battery system can be installed into a first vessel. This can involve installing the first containerized battery system to a designated container space on the first vessel, such as a space specifically reserved for containerized battery systems to provide power to the vessel.

At subsequent process step 908, movement of the first vessel can be facilitated using the first containerized battery system. This can be the result of coupling an electrical cojpling from the container to a power system on the vessel and drawing power from the battery cells within the containerized battery system, as detailed above regarding these and other steps.

At a following process step 910, the first containerized battery system can be removed from the first vessel. This can involve removing the first containerized battery system when it needs recharging, such as when the first vessel is in port, for example.

At the next process step 912, a second containerized battery system can be installed into the first vessel. Such an installation can take place, for example, at the same port where the first containerized battery system was removed. As will be readily appreciated, multiple depleted containerized battery systems can be removed from a given vessel and multiple other charged containerized battery systems can be installed to that vessel in a given situation.

At process step 914, the first containerized battery system can be recharged. This can take place where the first containerized battery system was removed from the first vessel. For example, a designated recharging station or area at a port where the first containerized battery system was removed from the first vessel can be used to recharge multiple containerized battery systems. This can take place while the first vessel is still in port or after it has left.

At process step 916, the status of the recharged first containerized battery system can be updated. This can be done automatically using the sensors and processor located at each battery cell on the first containerized battery system. The updated statuses can be communicated to a central battery management system, such as to let the central system know that the first containerized battery system is recharged and ready to be used again.

At process step 918, the first containerized battery system can be installed into a second vessel separate from the first vessel. This can take place where the first containerized battery system was recharged, such as the port where it was removed from the first vessel, for example. At the next process step 920, movement of the second vessel can then be facilitated using the first containerized battery system. Again, this can be accomplished using the same or similar devices and steps used above for moving the first vessel with the first containerized battery system. Also, multiple containerized battery systems can be used for such purposes, and all can be removed, recharged, and reinstalled to the same or other vessels in any combination desired, as will be readily appreciated. The method then ends at end step 922.

It will be appreciated that the foregoing method 900 may include additional steps not shown, and that not all steps are necessary in some embodiments. For example, additional steps may include automatically taking one or more battery cells offline, such as due to individual cell failure. Other process steps can involve tracking the locations of various different containerized battery systems to be aware of system amounts and availabilities in various ports. Furthermore, the order of steps may be altered as desired, and one or more steps may be performed simultaneously. For example, step 914 may be performed prior to or along with step 912. Other process steps, details, and arrangements will also be appreciated.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1. A containerized battery system, comprising:
a container having an outer housing, wherein the container is configured to be installed within and removed from a container space on a vessel;
a framework situated within the container, wherein the framework defines multiple framework compartments therein;
a plurality of battery cells arranged into multiple battery modules configured to provide power to the vessel, each battery module being removably disposed as a combined unit within a framework compartment, wherein each battery cell within a battery module is coupled together in parallel and the multiple battery modules are coupled together in series; and
an electrical coupling located along the outer housing of the container, wherein the electrical coupling is configured to facilitate the recharging of the plurality of battery cells while the battery cells are located within the container, and wherein each battery module includes spacing components configured to provide airflow spacing between separate battery modules.

2. The containerized battery system of claim 1, wherein the framework includes horizontally disposed stabilizing components situated across vertically disposed support stantions.

3. The containerized battery system of claim 1, wherein the framework compartments are situated within the framework in an arrangement that is at least two framework compartments tall by at least four framework compartments wide by at least four framework compartments long.

4. The containerized battery system of claim 3, wherein the framework compartments are situated within the framework in an arrangement that is four framework compartments tall by ten framework compartments wide by six framework compartments long.

5. (canceled)

6. The containerized battery system of claim 1, wherein each battery module includes at least four battery cells.

7. The containerized battery system of claim 6, wherein each battery module includes nine battery cells.

8. The containerized battery system of claim 1, wherein one or more of the multiple battery modules includes a switch configured to uncouple its respective battery module from the overall series of battery modules such that the remaining overall series of battery modules remain fully functional.

9. The containerized battery system of claim 1, wherein each battery cell is a lithium iron phosphate based battery having a voltage of about 1 to 4 volts.

10. The containerized battery system of claim 1, wherein the combined capacity of all battery cells is about two megawatt hours.

11. The containerized battery system of claim 1, wherein each battery cell has a fuse coupled thereto to allow its respective battery module to remain functional in the event of a failure of any battery cell within the battery module.

12. The containerized battery system of claim 1, further comprising: a fire prevention system located within the container, wherein the fire prevention system is configured to scavenge oxygen inside the container, to maintain an internal pressure within the containerized battery system that is greater than the ambient pressure outside the containerized battery system, or both.

13. (canceled)

14. The containerized battery system of claim 1, further comprising:
an environmental control system located within the container, wherein the environmental control system provides cooling within the containerized battery system without any air exchange between the air inside the container and ambient air outside the container.

15. The containerized battery system of claim 14, wherein the environmental control system is configured to maintain the temperature within the containerized battery system at between about 25 to 30 degrees C.

16. The containerized battery system of claim 1, further comprising:
an environmental control system located within the container, wherein the environmental control system prevents ambient air outside the container from entering the container.

17. (canceled)

18. The containerized battery system of claim 1, further comprising: a power management system component located about the container, wherein the power management system component is configured to collect data regarding the status of the battery cells located within the containerized battery system and communicate the data to one or more entities located outside the containerized battery system along power lines coupled to the battery cells that also transmit power from the battery cells wherein the power management system component includes at least one separate sensor and at least one separate processor located at every battery cell.

19. The containerized battery system of claim 1, wherein the container is about 4 feet tall by about 20 feet long by about 8 feet wide.

20. The containerized battery system of claim 1, wherein the container is about 8 feet tall by about 20 feet long by about 8 feet wide.

21. (canceled)

22. (canceled)

23. (canceled)

24. (canceled)

25. A containerized battery system, comprising
a container having an outer housing, wherein the container is configured to be installed within and removed from a container space on a vessel;
a framework situated within the container, wherein the framework defines multiple framework compartments therein;
a plurality of battery cells arranged into multiple battery modules configured to provide power to the vessel, each battery module being removably disposed as a combined unit within a framework compartment, wherein each battery cell within a battery module is coupled together in parallel and the multiple battery modules are coupled together in series; and
an electrical coupling located along the outer housing of the container, wherein the electrical coupling is configured to facilitate the recharging of the plurality of battery cells while the battery cells are located within the container, and wherein the framework compartments are situated within the framework in an arrangement that is at least two framework compartments tall by at least four framework compartments wide by at least four framework compartments long.

26. The containerized battery system of claim 25, wherein the framework compartments are situated within the framework in an arrangement that is four framework compartments tall by ten framework compartments wide by six framework compartments long.

27. A containerized battery system, comprising:
a container having an outer housing, wherein the container is configured to be installed within and removed from a container space on a vessel;
a framework situated within the container, wherein the framework defines multiple framework compartments therein;
a plurality of battery cells arranged into multiple battery modules configured to provide power to the vessel, each battery module being removably disposed as a combined unit within a framework compartment, wherein each battery cell within a battery module is coupled together in parallel and the multiple battery modules are coupled together in series;
an electrical coupling located along the outer housing of the container, wherein the electrical coupling is configured to facilitate the recharging of the plurality of battery cells while the battery cells are located within the container; and
a fire prevention system located within the container, wherein the fire prevention system is configured to scavenge oxygen inside the container, to maintain an internal pressure within the containerized battery system that is greater than the ambient pressure outside the containerized battery system, or both.

28. A containerized battery system, comprising:
a container having an outer housing, wherein the container is configured to be installed within and removed from a container space on a vessel;
a framework situated within the container, wherein the framework defines multiple framework compartments therein;
a plurality of battery cells arranged into multiple battery modules configured to provide power to the vessel, each battery module being removably disposed as a combined unit within a framework compartment, wherein each battery cell within a battery module is coupled together in parallel and the multiple battery modules are coupled together in series;
an electrical coupling located along the outer housing of the container, wherein the electrical coupling is configured to facilitate the recharging of the plurality of battery cells while the battery cells are located within the container, and wherein the container is about 4 feet tall by about 20 feet long by about 8 feet wide; and
an environmental control system located within the container, wherein the environmental control system provides cooling within the containerized battery system.
